(19) United States
(12) Patent Application Publication
(10) Pub. No.: US 2021/0008665 A1
(43) Pub. Date: Jan. 14, 2021

(54) METHOD FOR WELDING COATED STEEL PLATES

(71) Applicant: voestalpine Automotive Components Linz GmbH, Linz (AT)

(72) Inventor: Gerald Brugger, Linz (AT)

(21) Appl. No.: 17/032,840

(22) Filed: Sep. 25, 2020

Related U.S. Application Data
(63) Continuation of application No. PCT/EP19/54890, filed on Feb. 27, 2019.

(30) Foreign Application Priority Data
Mar. 27, 2018 (DE) 10 2018 107 291.0

(51) Int. Cl. B23K 26/322; B23K 26/00; B23K 26/08; B23K 26/211; B23K 26/26

(52) U.S. Cl. CPC B23K 26/322; B23K 26/0006; B23K 26/083; B23K 35/36; B23K 26/211; B23K 26/26; B23K 26/0093

(57) ABSTRACT

The disclosure relates to a method for welding steel sheets made of steel materials coated with an aluminum silicon anti-corrosion layer, in particular CMnB and CMn steel materials that can be hardened using the quench hardening method, wherein a welding filler rod is used in the welding of the sheets and the welding filler rod has the composition: C=0.80-2.28×% C base material, Cr=8-20, Ni<5, Si=0.2-1, Mn=0.2-1, Mo<2, with the rest being composed of iron and unavoidable smelting-related impurities and with all indications expressed in % by mass.

### CROSS-REFERENCE TO RELATED APPLICATIONS

This application is a Continuation of and claims the benefit of priority under 35 USC 120 to PCT/EP2019/054890 filed Feb. 27, 2019, which claims priority to DE 10 2018 107 291.0 filed Mar. 27, 2018, the entire contents of each are hereby incorporated by reference.

The present disclosure relates to a method for welding coated steel.

In the prior art, it is known to use steel sheets of different thicknesses and/or steel sheets of different compositions to produce welded sheet bars, which can then undergo further processing such as a forming process or heat treatment.

The purpose of this is that the different thicknesses or the different compositions allow the properties of a completely formed component to be embodied differently from one zone to another.

It is also known to weld sheets that have an anti-corrosion coating and in particular, a metallic anti-corrosion coating such as a zinc or aluminum coating.

In particular, it is known to weld high hardenability manganese boron steels to each other, which are then used to produce structural components of vehicle bodies.

Such custom-made sheet bars composed of steel sheets are also referred to as “tailored blanks.”

Known welding methods include arc welding, laser welding, and the laser arc hybrid welding method.

Particularly with aluminum silicon-coated sheets, it has turned out that the aluminum silicon layer causes problems in the welding of the sheet when conventional welding methods are involved. Clearly, the coating elements have a negative influence on the composition of the welding seam. Strategies have therefore been developed for removing aluminum silicon layers in some sub-regions before the welding in order to reduce the aluminum silicon concentration in the welding seam.

When welding such coated sheets, it is also known from the prior art for a filler rod to be used or for a powder to be added.

Welded sheet bars of this kind are also used in the production of hardened or partially hardened components and for this purpose, are heated and quenched.

It is know that so-called press hardened components composed of sheet steel are particularly used in automobiles. These press hardened components composed of sheet steel are high-strength components that are particularly used as safety components in the vehicle body sector. In this case, the use of these high-strength steel components makes it possible to reduce the material thickness relative to a normal-strength steel and thus to achieve low vehicle body weights.

In press hardening, there are basically two different possibilities for producing such components. These are commonly referred to as the direct and indirect methods.

In the direct method, a sheet steel sheet bar is heated to above what is referred to as the austenitization temperature and possibly kept at this temperature until a desired degree of austenitization is achieved. Then this heated sheet bar is transferred to a forming tool and in this forming tool, is formed into the finished component in a one-stage forming step and in the process of this, is simultaneously cooled by means of the cooled forming tool at a speed greater than the critical hardening speed. This produces the hardened component.

In the indirect process, first the component is almost completely formed, possibly in a multi-stage forming process. This formed component is then likewise heated to a temperature greater than the austenitization temperature and possibly kept at this temperature for a desired necessary time.

Then this heated component is transferred to and inserted into a forming tool, which already has the dimensions of the component or more precisely, the final dimensions of the component, possibly taking into account the thermal expansion of the preformed component. Consequently, after the—in particular cooled—tool is closed, all that happens in this tool is that the preformed component is cooled at a speed greater than the critical hardening speed and therefore hardened.

In this connection, the direct method is a little simpler to carry out, but only enables shapes that can actually be achieved with a single forming step, i.e. relatively simple profile shapes.

The indirect method is a little more complex, but is also able to achieve more complex shapes.

DE 10 2012 111 118 B3 has disclosed a method for laser welding one or more workpieces composed of press-hardenable steel, in particular manganese boron steel, in which the welding is carried out in a butt joint and in which the workpiece has or the workpieces have a thickness of at least 1.8 mm and/or a thickness difference of at least 0.4 mm is produced at the butt joint, where during the laser welding, a filler rod fed is fed into the weld pool that is produced with a laser beam. In order to ensure that during the hot-forming, the welding seam can reliably harden into a martensitic structure, this document provides for adding at least 1 alloying element from the group including manganese, chromium, molybdenum, silicon, and/or nickel to the filler rod thus promoting the formation of austenite in the weld pool that is produced with the laser beam, this at least one alloying element being present in the filler rod with a mass percentage that is at least 0.1 percent by weight greater than in the press-hardenable steel of the workpiece or workpieces.

DE 10 2014 001 979 A1 has disclosed a method for laser welding one or more workpieces composed of hardenable steel in the butt joint, the steel particularly being a manganese boron steel and the workpieces having a thickness of between 0.5 and 1.8 mm and/or with a thickness difference of between 0.2 and 0.4 mm being produced in the butt joint; in the laser welding, a filler rod is introduced into the weld pool and the weld pool is produced exclusively by the one laser beam. In order to ensure that during the hot-forming, the welding seam can reliably harden into a martensitic structure, this document provides for the filler rod to contain at least one alloying element from the group including manganese, chromium, molybdenum, silicon, and/or nickel, thus promoting the formation of austenite.

EP 2 737 971 A1 has disclosed a tailor welded blank and a method for producing it in which the sheet is produced in that sheets of different thicknesses or compositions are bonded to one another and which is supposed to reduce quality problems in the welding zone. Here, too, a filler rod is used, the latter being embodied so that in the temperature range from 800 to 950° C., no ferrite is produced. This method is supposed to be particularly suitable for AlSi-coated sheets; this rod should also have a higher content of austenite-stabilizing elements, which in particular consist of carbon or manganese.

EP 1 878 531 B1 has disclosed a method for hybrid laser arc welding of surface-coated metallic workpieces, the intent being for the surface coating to contain aluminum. The laser beam is supposed to be combined with at least one arc so that a melting of the metal and a welding of the part or parts is produced and before being welded, at least one of the parts has deposits of the aluminum silicon coating on the surface of one of its lateral edges that are to be welded.

EP 2 942 143 B1 has disclosed a method for joining two blanks; the blanks are steel sheets with a coating that comprises a layer composed of aluminum or an aluminum alloy; the two parts are welded to each other using a laser beam and an arc; the arc welding torch comprises a filler wire electrode and the filler wire electrode consists of a steel alloy that contains stabilizing elements; the laser and arc are moved in a welding direction; and the arc welding torch and laser beam are positioned successively in the welding direction.

EP 2 883 646 B1 has disclosed a method for joining two blanks in which at least one of the blanks comprises a layer composed of aluminum or an aluminum alloy, a metal powder is introduced into the welding zone during the welding procedure, and the metal powder is an iron-based powder containing gamma-stabilizing elements and the laser beam welding is a two-point laser beam welding.

EP 2 007 545 B1 has disclosed a method for producing a welded part with very good mechanical properties in which a steel sheet has a coating that consists of an intermetallic layer and a metal alloy layer situated on the intermetallic layer. For the welding of the sheets, the metal alloy layer on the intermetallic layer should be removed at the periphery of the sheet, i.e. the regions that are to be welded, this intermetallic layer being an aluminum alloy layer. This coating should be removed by a laser beam so that this layer, which is embodied as an aluminum silicon layer, is vaporized before the welding in order to avoid harmful influences of the aluminum in the welding seam. At the same time, the intermetallic layer should be left behind in order to produce corrosion-inhibiting effects if possible.

U.S. Pat. No. 9,604,311 B2 has disclosed a complete ablation process in which a metallic layer and an intermetallic layer are completely vaporized by laser.

In the prior art, each of which is hereby incorporated by reference in their entirety, it is disadvantageous in that methods in which a powder is introduced into the welding seam, it is difficult to meter the powder. Laser hybrid welding methods have the disadvantage of being basically very complex and difficult to manage. Scale formation on the welding seam has the disadvantage of reducing the load-bearing cross-section and decarburization of the welding seam likewise has the disadvantage of reducing the load-bearing cross-section, but also jeopardizes the mechanical load capacity of the welding seam. Ablation of aluminum silicon layers by means of a laser has the disadvantage on the one hand that it is difficult to reliably guide the laser ablation and to achieve a reliable ablation and on the other hand, such a step constitutes an additional processing step that makes the production more complex and costly.

Basically, the problem is that in aluminum silicon layers on sheets, upon welding, the welding seam is not as strong, which is clearly due to the aluminum that is introduced into the welding seam along with this powder. The object of the disclosure is to produce stabile welding seams at a low cost.

According to the disclosure, aluminum silicon-coated sheets without the aluminum silicon layer must be entirely or partially removed are welded to each other, but the negative influence of the aluminum on the mechanical properties of the welded connection is neutralized. Also according to the disclosure, the decarburization of and scale formation on the welding seam are prevented, the high-temperature strength of the welding seam is increased, and the welding seam is also toughened for subsequent hot forming processes in such a way that the tool-dictated less favorable cooling conditions prevailing in the welding seam are compensated for. For the neutralization of the aluminum and its negative effects according to the disclosure, the welding is carried out with a special filler rod whose chemistry and alloy level are calibrated to counteract the effects of the aluminum.

In particular, the welding wire has a defined chromium content, which sharply inhibits the scale formation and edge decarburization.

Correspondingly, by contrast with the prior art, no gamma stabilization is carried out and instead, the welding is performed with little nickel and manganese. It has surprisingly turned out that a high-strength welding seam is nevertheless produced. It therefore succeeds in achieving an ablation-free welding and in suppressing the negative influence of aluminum on the mechanical properties of the welded connection; in addition, it almost entirely prevents a decarburization of and scale formation on the welding seam and increases the high-temperature strength of the welding seam. Among other things, this makes it possible to weld with an increased chromium content, which improves the hardenability. This is important because according to the disclosure, it has been discovered that in the hot forming process, depending on the tool, less favorable cooling conditions are often present at the welding seam, which is reflected in a decrease in hardness of the welding seam after the press hardening procedure.

All in all, therefore, through the use of a filler rod especially adapted to the material, it is possible to largely neutralize the aluminum and through the chromium content in the welding seam, to sharply inhibit scale formation and edge decarburization. A suitable filler rod has a carbon content that corresponds to 0.80 to 2.28 times the carbon content of the base material, preferably 0.88 to 1.51 times the carbon content of the base material, particularly preferably 0.90 to 1.26 times the carbon content of the base material, even more particularly preferably 0.90 to 1.17 times the carbon content of the base material, with a chromium content of 8 to 20%, a nickel content below 5%, preferably below 1%, a silicon content of 0.2 to 3%, a manganese content of 0.2 to 1%, and optionally a molybdenum content of up to 2%, preferably 0.5 to 2%.

Welding with such a filler rod succeeds in sharply inhibiting scale formation and edge decarburization in the subsequent hardening process and in “neutralizing” the effect of the aluminum from the description.

The disclosure will be explained below by way of example based on the drawings. In the drawings:

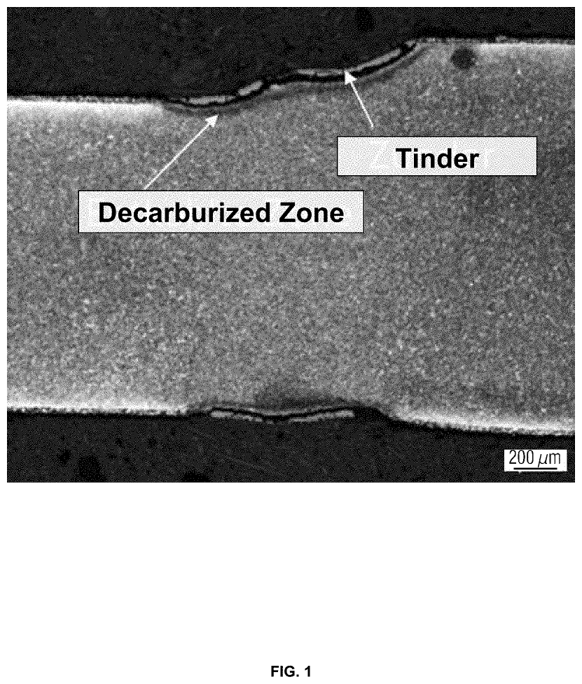

FIG. 1 shows a cross-section through a welding seam between two sheets of different thicknesses; a welding method according to the prior art has been used and a welding seam with scale formation and decarburization is visible;

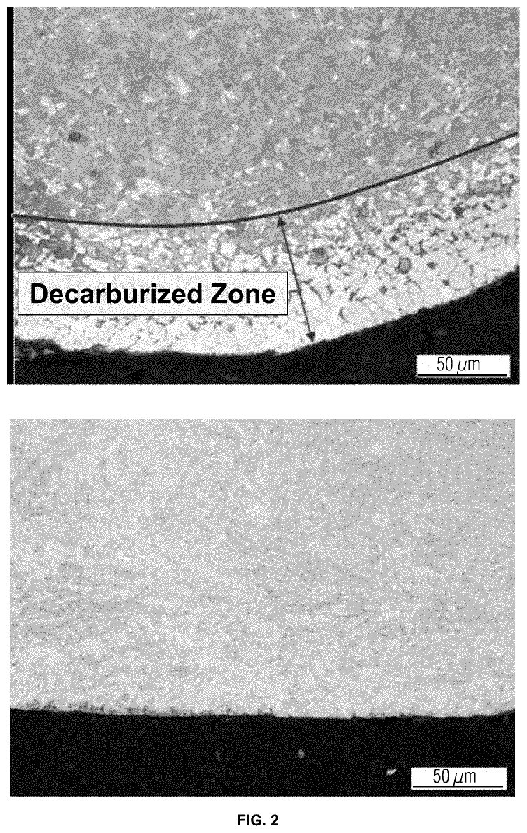

FIG. 2 shows a polished cross-section of the decarburized zone in a welding seam according to the prior art and a welding seam according to the disclosure;

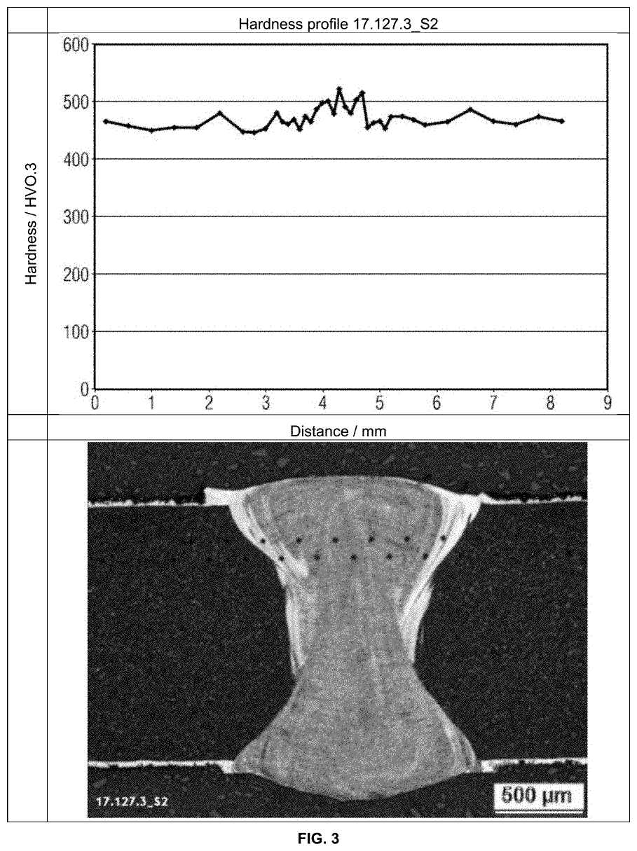

FIG. 3 shows the hardness curve within a welding seam; the welding seam is shown in a micrograph with the hardness sample points;

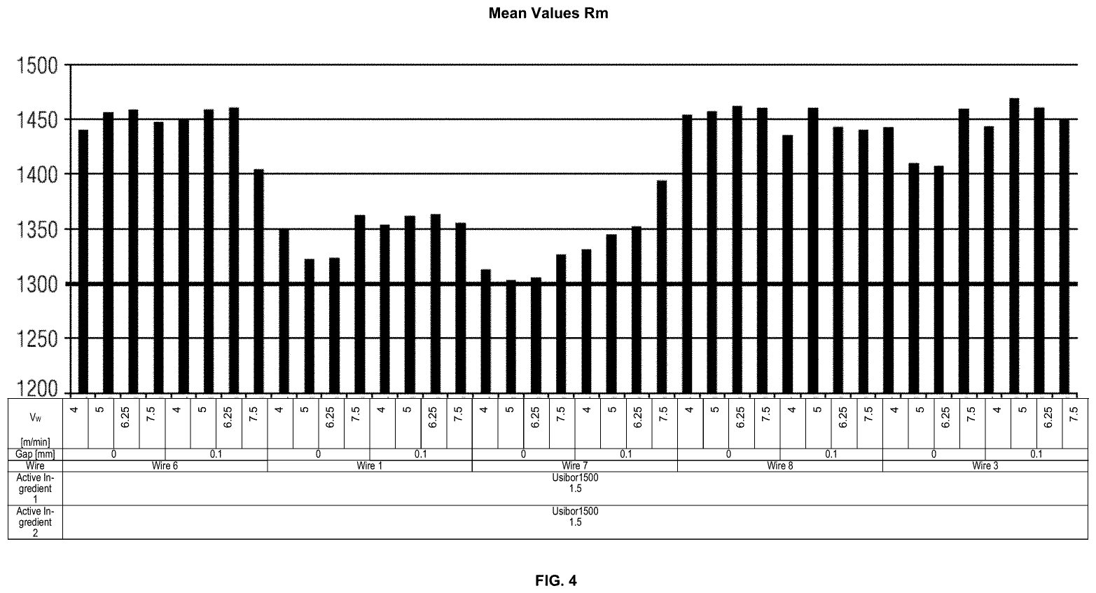

FIG. 4 shows an overview of the strength levels of welding seams with different gap widths and different wire materials—both according to the disclosure and not according to the disclosure—and different weld advancing speeds;

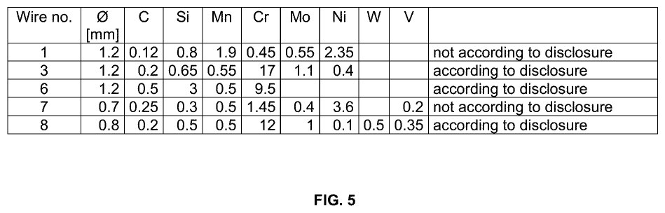

FIG. 5 shows an overview of the compositions of the filler rods composed of the wire materials according to the disclosure and not according to the disclosure that are shown in FIG. 4.

According to the disclosure, the welding of two sheets of different thicknesses, preferably CMn steels, particularly of a hardenable CMnB steel, in particular 22MnB5 steel materials, is carried out using a welding filler rod. In particular according to the disclosure, aluminum silicon-coated steel sheets with >900 MPa tensile strength after hardening are joined in an ablation-free way by welding.

The preferred chemical alloy of the filler rod or filler wire consists of the following elements:

C=0.80-2.28×C base material
Cr=8-20% by mass
Ni≤5, preferably ≤1% by mass
Si=0.2-3% by mass
Mn=0.2-1% by mass
optionally Mo=<2, preferably 0.5-2.5% by mass
optionally V and/or W totaling <1% by mass
residual iron and unavoidable smelting-related impurities

Preferably, the carbon of the filler rod or filler wire is adjusted as follows or more precisely, the filler rod has the following composition:

C=0.88 to 1.51×C base material
Cr=10-18% by mass
Ni=≤1% by mass
Si=0.3-1% by mass
Mn=0.4-1% by mass
Mo=0.5-1.3% by mass
V=0.1-0.5% by mass
W=0.1-0.5% by mass
residual iron and unavoidable smelting-related impurities
Particularly preferably:
C=0.90 to 1.26×C base material
Even more particularly preferably:
C=0.90 to 1.17×C base material

As has already been explained above, aluminum silicon-coated sheets with a layer of 60 g/m² per side composed of a 22MnB5 are joined, wherein for purposes of the tensile specimens, 1.5 mm sheets were joined. Such sheets were provided with welded edges and were welded with a Trumpf 4006 welding laser (4.4 kW) with a focal length diameter of 0.6 mm.

The base material is a steel of the following general alloy composition (in % by mass):

| | |
|---|---|
| carbon (C) | 0.03-0.6 |
| manganese (Mn) | 0.8-3.0 |
| aluminum (Al) | 0.01-0.07 |
| silicon (Si) | 0.01-0.8 |
| chromium (Cr) | 0.02-0.6 |
| nickel (Ni) | <0.5 |
| titanium (Ti) | 0.01-0.08 |
| niobium (Nb) | <0.1 |
| nitrogen (N) | <0.02 |
| boron (B) | 0.002-0.02 |
| phosphorus (P) | <0.01 |
| sulfur (S) | <0.01 |
| molybdenum (Mo) | <1 |

residual iron and smelting-related impurities.

This means that the carbon content of the filler rod can be in the range from 0.024 to 1,086% by mass.

Naturally, the carbon content of the filler rod is selected specifically based on the carbon content of the base material that is present in production.

Preferably, the base material can have the following alloy composition:

| | |
|---|---|
| carbon (C) | 0.03-0.36 |
| manganese (Mn) | 0.3-2.00 |
| aluminum (Al) | 0.03-0.06 |
| silicon (Si) | 0.01-0.20 |
| chromium (Cr) | 0.02-0.4 |
| nickel (Ni) | <0.5 |
| titanium (Ti) | 0.03-0.04 |
| niobium (Nb) | <0.1 |
| nitrogen (N) | <0.007 |
| boron (B) | 0.002-0.006 |
| phosphorus (P) | <0.01 |
| sulfur (S) | <0.01 |
| molybdenum (Mo) | <1 |

residual iron and smelting-related impurities.

Specifically, for example, the 22MnB5 can have the following composition:

### C=0.22

### Si=0.19

### Mn=1.22

### P=0.0066

### S=0.001

### Al=0.053

### Cr=0.26

### Ti=0.031

### B=0.0025

### N=0.0042,

residual iron and smelting-related impurities, with all indications expressed in % by mass.

With this specific composition of the base material, the carbon content of the filler rod can lie in the range from 0.186 to 0.5082% by mass, particularly preferably between 0.216 and 0.257% by mass.

In the course of the trials the process parameters were varied as follows:
Trumpf 4006 welding laser 4.4 kW (focal length Ø=0.6 mm)
Variation of process parameters:
   v_{w}=4-7.5 m/min
   V_{d}=2.3-6.4 m/min
   gap=0/0.1 mm
hardening
   furnace temperature: 930° C.
   furnace dwell time: 310 sec
   transfer time: approx. 6 sec
   water-cooled sheet die
      where v_{w} is the weld advancing speed and V_{d} is the rod feed speed.

Then the hardening of the samples was carried out at 930° C. furnace temperature and with a furnace dwell time of 310 seconds. The transfer time between removal from furnace and insertion into a water-cooled sheet die was 6 seconds. The welding with welding wires according to the disclosure resulted in welding seams shown at the bottom in FIG. 2. A homogeneous structure is apparent, without a decarburized zone as shown at the top in FIG. 2, which shows a welding seam according to the prior art. Such a welding seam according to the prior art is also shown in FIG. 1 in which a clear scale formation and an underlying decarburized zone are visible. The scale formation on the welding seam reduces the load-bearing cross-section and the decarburization of the welding seam likewise reduces the load-bearing cross-section so that in this case, the tensile specimens tear in the vicinity of the welding seam. The goal, however, must be for the tensile specimens to not tear at the welding seam, but rather in the base material, thus ensuring that it is the base material that determines the mechanical properties.

FIG. 3 shows the hardness curve in a welding seam that is welded with a filler wire according to the disclosure; the hardness recording points are visible on the right in FIG. 3 and the corresponding hardness curve is shown on the left in FIG. 3. It is clear that there are indeed slight fluctuations in the hardness curve, but these have values in the upper range and in no way decrease compared to the edge zones or the base material. FIG. 4 shows the averages of tensile specimens; different wire materials and different advancing speeds as well as different gap widths were used.

The wire materials 1 and 7 in this case were assessed to be unsuitable whereas the wire materials 3, 6, and 8 have the composition according to the disclosure and have the lowest range of fluctuation throughout the entire process and all of the processing possibilities. It is noteworthy that the samples welded with the wire materials according to the disclosure greatly exceed the minimum strength specified by most users. The wire compositions are summarized in FIG. 5.

The following compositions of wire material were tested (see FIG. 5)

| Wire | Ø | | | | | | | | | |
|---|---|---|---|---|---|---|---|---|---|---|
| no. | [mm] | C | Si | Mn | Cr | Mo | Ni | W | V | |
| 1 | 1.2 | 0.12 | 0.8 | 1.9 | 0.45 | 0.55 | 2.35 | | | not according to disclosure |
| 3 | 1.2 | 0.2 | 0.65 | 0.55 | 17 | 1.1 | 0.4 | | | according to disclosure |
| 6 | 1.2 | 0.5 | 3 | 0.5 | 9.5 | | | | | according to disclosure |
| 7 | 0.7 | 0.25 | 0.3 | 0.5 | 1.45 | 0.4 | 3.6 | | 0.2 | not according to disclosure |
| 8 | 0.8 | 0.2 | 0.5 | 0.5 | 12 | 1 | 0.1 | 0.5 | 0.35 | according to disclosure |

All values in % by mass, residual iron and unavoidable smelting-related impurities.

The wires with the numbers 3, 6, and 8 in this case exhibited particularly advantageous properties, but wire number 6 exhibited the fracture pattern shown and a possible susceptibility to brittle fracture due to the somewhat elevated carbon and silicon content. All in all, however, the results achieved with all of these wires were assessed as satisfactory.

As mentioned previously, these strength value results are shown in FIG. 4

With the disclosure, it is advantageous that without a costly ablation step that cannot be reliably controlled, aluminum silicon-coated hardenable steel sheets, particularly composed of a hardenable boron manganese steel, especially a steel from the family of MnB steels, preferably a 22MnB5 or 20MnB8, can be welded to each other without the welding seam constituting a weak point.

Naturally, however, the disclosure can also be used for less high-strength steel alloys like so-called soft partner materials such as 6Mn6, 6Mn3, or 8MnB7.

What is claimed:

1. A method for welding steel sheets made of steel materials coated with an aluminum silicon anti-corrosion layer, in particular CMnB and CMn steel materials that can be hardened using the quench hardening method, wherein a welding filler rod is used in the welding of the sheets and the welding filler rod is of the following composition:
C=0.80 -2.28×% C base material
Cr=8-20%
Ni<5%
Si=0.2-3%
Mn=0.2-1%
optionally Mo<2%
optionally V and/or W totaling <1%
residual iron and unavoidable smelting-related impurities, with all indications expressed in % by mass.

2. The method according to claim 1, wherein a welding wire is used having a nickel content below 1% by mass.

3. The method according to claim 1, wherein the welding wire has a molybdenum content of 0.5 to 2% by mass.

4. The method according to claim 1, wherein the sheets are laser butt welded.

5. The method according to claim 1, wherein the weld advancing speed is 4 to 15 m/min.

6. The method according to claim 1, wherein gap widths of 0 to 0.3 mm, in particular 0 to 0.1 mm, are set.

7. The method according to claim 1, wherein the carbon content of the filler rod is set to
C=0.88 to 1.51×C base material,
preferably
C=0.90 to 1.26×C base material,
and particularly preferably
C0.90 to 1.17×C base material.

8. The method according to claim 1, wherein for the base material, a steel is used, which is a boron manganese steel that can be hardened by means of an austenitization and quench hardening process, particularly preferably to a tensile strength of greater than 900 MPa, and in particular, a steel from the group of CMnB steels is used, for example 22MnB5 or 20MnB8.

9. The method according to claim 1, wherein a steel of the general alloy composition (in % by mass) is:

| | |
|---|---|
| carbon (C) | 0.03-0.6 |
| manganese (Mn) | 0.3-3.0 |
| aluminum (Al) | 0.01-0.07 |
| silicon (Si) | 0.01-0.8 |
| chromium (Cr) | 0.02-0.6 |
| nickel (Ni) | <0.5 |
| titanium (Ti) | 0.01-0.08 |
| niobium (Nb) | <0.1 |
| nitrogen (N) | <0.02 |
| boron (B) | <0.02 |
| phosphorus (P) | <0.01 |
| sulfur (S) | <0.01 |
| molybdenum (Mo) | <1; and |

residual iron and smelting-related impurities is used as the base material.

10. The method according to claim 9, wherein a steel of the general alloy composition (in % by mass) is:

| | |
|---|---|
| carbon (C) | 0.03-0.36 |
| manganese (Mn) | 0.3-2.00 |
| aluminum (Al) | 0.03-0.06 |
| silicon (Si) | 0.01-0.20 |
| chromium (Cr) | 0.02-0.4 |
| nickel (Ni) | <0.5 |
| titanium (Ti) | 0.03-0.04 |
| niobium (Nb) | <0.1 |
| nitrogen (N) | <0.007 |
| boron (B) | <0.006 |
| phosphorus (P) | <0.01 |
| sulfur (S) | <0.01 |
| molybdenum (Mo) | <1; and |

residual iron and smelting-related impurities is used as the base material.

11. The method according to claim 9, wherein a steel of the alloy composition C=0.22, Si=0.19, Mn=1.22, P=0.0066, S=0.001, Al=0.053, Cr=0.26, Ti=0.031, B=0.0025, N=0.0042, residual iron, and smelting-related impurities is used as the base material, with all of the above indications expressed in % by mass.

12. The method according to claim 9, wherein the filler rod has a carbon content in the range from 0.024 to 1.086% by mass, particularly preferably 0.186 to 0.5082% by mass, and more particularly preferably between 0.20 and 0.257% by mass.

13. A sheet bar comprising a first steel sheet and a second steel sheet, which are welded to each other using a method according to one of the preceding claims.

14. The sheet bar according to claim 13, wherein the steel sheets have different alloy compositions.

15. A press hardened component, wherein a sheet bar according to claim 13 is subjected to a hot forming or cold forming and a subsequent press hardening.
